(19) United States
(12) Patent Application Publication
(10) Pub. No.: US 2015/0325032 A1
(43) Pub. Date: Nov. 12, 2015

(54) HYBRID MODE GRAPHICS PROCESSING INTERPOLATOR

(71) Applicant: Samsung Electronics Company, Ltd., Suwon-Si (KR)

(72) Inventors: Yang Jiao, San Jose, CA (US); Mitchell Alsup, Austin, TX (US)

(21) Appl. No.: 14/502,852

(22) Filed: Sep. 30, 2014

Related U.S. Application Data
(60) Provisional application No. 61/991,349, filed on May 9, 2014.

(51) Int. Cl. G06T 15/00; G06T 1/60

(52) U.S. Cl. CPC G06T 15/005; G06T 1/60; G06T 2200/28

(57) ABSTRACT

A method for processing pixel information includes pushing pixel varying attributes to a register file of a shader processing element. At least a portion of the pixel varying attributes are pulled based on a control flow in the shader processing element. At least a portion of the pixel varying attributes are interpolated.

### CROSS-REFERENCE TO RELATED APPLICATIONS

This application claims the priority benefit of U.S. Provisional Patent Application Ser. No. 61/991,349, filed May 9, 2014, which is incorporated herein by reference in its entirety.

### TECHNICAL FIELD

One or more embodiments generally relate to graphics processing and, in particular, a hybrid mode interpolator for graphics processing.

### BACKGROUND

Graphics rendering on graphical processing units (GPUs) requires large amount of computation in pixel varying attribute interpolation, which uses a lot of energy and silicon area.

### SUMMARY

One or more embodiments generally relate to graphics processing using a hybrid mode interpolator for resource reduction. In one embodiment, a method for processing pixel information includes pushing pixel varying attributes to a register file of a shader processing element. In one embodiment, at least a portion of the pixel varying attributes are pulled based on a control flow in the shader processing element. In one embodiment, said at least a portion of the pixel varying attributes are interpolated.

In one embodiment, a method for processing pixel information includes pushing pixel varying attributes to a texture unit. In one embodiment, at least a portion of the pixel varying attributes are pulled based on a control flow in the shader processing element. In one embodiment, said at least a portion of the pixel varying attributes is interpolated.

In one embodiment, a GPU for an electronic device comprises one or more processing elements coupled to a memory device. In one embodiment, the one or more processing elements: push pixel varying attributes to a register file for a shader processing element, provide functionality to the shader processing element for pulling at least a portion of the pixel varying attributes based on a control flow in the shader processing element, and perform interpolation using an interpolation unit for said at least a portion of the pixel varying attributes.

In one embodiment, a GPU for an electronic device comprises one or more processing elements coupled to a memory device. In one embodiment, the one or more processing elements: push pixel varying attributes to a texture unit, provide functionality to a shader processing element for pulling at least a portion of the pixel varying attributes based on a control flow in the shader processing element, and perform interpolation using an interpolation unit for said at least a portion of the pixel varying attributes.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of architecture for a system including a mobile device including a graphical processing unit (GPU) module, according to an embodiment.

FIG. 3 shows an example triangle scheme used for attribute interpolation, according to an embodiment.

FIG. 4A shows an example block diagram for an interpolator unit top-level data flow, according to an embodiment.

FIG. 4B shows an example block diagram for an interpolator (IPA), according to an embodiment.

FIG. 5 shows an example arithmetic logic unit (ALU) block diagram, according to an embodiment.

FIG. 6 shows an example position and attribute manager (PAM) block diagram, according to an embodiment.

FIG. 7 shows an example pull request buffer (PRB) block diagram, according to an embodiment.

FIG. 8 shows a block diagram for a process for hybrid mode interpolation processing, according to one embodiment.

FIG. 9 is a high-level block diagram showing an information processing system comprising a computing system implementing one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments generally relate to graphics processing using a hybrid mode interpolator for resource reduction. In one embodiment, a fixed function interpolator is implemented that interacts with the shader core to reduce resource consumption, such as power and physical hardware area in most common performance cases while still supporting the complete specification of advanced graphics APIs.

In one embodiment, several power and area optimizations are provided, such as adaptively calculating a plane equation base parameter in a setup unit, interpolating at 4×4, 8×8 or larger size blocks (instead of 2×2 quads) in the interpolator unit to save computations, sharing a large block interpolator with reciprocal quadratic interpolation logic used for perspective division (for saving physical hardware area), and intelligent scheduling for maximizing the efficiency of the interpolator.

In one or more embodiments, a hybrid push and pull mode is used to support the complete OpenGL 4.3 and DirectX 11 functionality and maximize power saving for most common performance cases. In one embodiment, the push mode provides the interpolator (IPA) to interpolate the pixel varying attributes based on the Rasterizer output pixel location and valid mask information without Shader Core intervention.

In one or more embodiments, the push mode includes benefits, such as: removing interpolation instructions, division or reciprocal and multiplication instructions required by perspective correction, and preamble texture instructions from the Shader program executed in the Shader Processing Elements (PE); saves Shader PE energy and area on instruction fetch, decode, scheduling and execution as Shader execution is more expensive in terms of energy and area; simplifies Shader PE scheduling, instruction issuance and pipeline control; allows direct forwarding to the Texture unit (TEX) for preamble texture processing; reduces the Shader PE hardware cost for texture latency compensation and reduces energy by eliminating extra data movement between the IPA, PE and TEX; supports Shader bypass to power down entire Shader PE(s); and releases plane equation data earlier to save physical storage area.

In one embodiment, a method provides for processing pixel information. In one embodiment, pixel varying attributes are pushed to a register file of a shader processing element. In one embodiment, at least a portion of the pixel varying attributes are pulled based on a control flow of the shader processing element. In one embodiment, interpolation is performed for the at least a portion of pixel varying attributes.

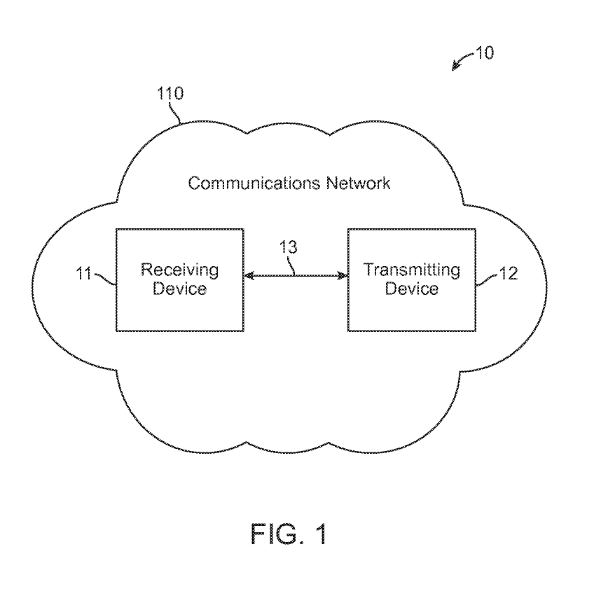

FIG. 1 is a schematic view of a communications system 10, in accordance with one embodiment. Communications system 10 may include a communications device that initiates an outgoing communications operation (transmitting device 12) and a communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include multiple transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., an IEEE 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, the communications network 110 may support protocols used by wireless and cellular phones and personal email devices (e.g., a Blackberry®). Such protocols may include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 110, may communicate over a bidirectional communication path such as path 13, or over two unidirectional communication paths. Both the transmitting device 12 and receiving device 11 may be capable of initiating a communications operation and receiving an initiated communications operation.

The transmitting device 12 and receiving device 11 may include any suitable device for sending and receiving communications operations. For example, the transmitting device 12 and receiving device 11 may include mobile telephone devices, television systems, cameras, camcorders, a device with audio video capabilities, tablets, wearable devices, and any other device capable of communicating wirelessly (with or without the aid of a wireless-enabling accessory system) or via wired pathways (e.g., using traditional telephone wires). The communications operations may include any suitable form of communications, including for example, voice communications (e.g., telephone calls), data communications (e.g., e-mails, text messages, media messages), video communication, or combinations of these (e.g., video conferences).

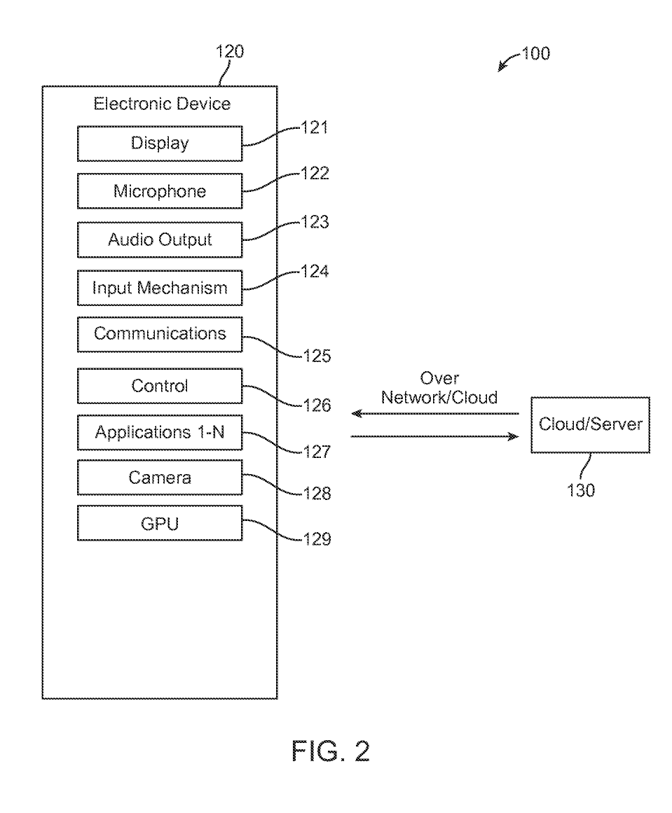

FIG. 2 shows a functional block diagram of an architecture system 100 that may be used for graphics processing in an electronic device 120. Both the transmitting device 12 and receiving device 11 may include some or all of the features of the electronics device 120. In one embodiment, the electronic device 120 may comprise a display 121, a microphone 122, an audio output 123, an input mechanism 124, communications circuitry 125, control circuitry 126, a camera module 128, a GPU module 129, and any other suitable components. In one embodiment, applications 1-N 127 are provided and may be obtained from a cloud or server 130, a communications network 110, etc., where N is a positive integer equal to or greater than 1.

In one embodiment, all of the applications employed by the audio output 123, the display 121, input mechanism 124, communications circuitry 125, and the microphone 122 may be interconnected and managed by control circuitry 126. In one example, a handheld music player capable of transmitting music to other tuning devices may be incorporated into the electronics device 120.

In one embodiment, the audio output 123 may include any suitable audio component for providing audio to the user of electronics device 120. For example, audio output 123 may include one or more speakers (e.g., mono or stereo speakers) built into the electronics device 120. In some embodiments, the audio output 123 may include an audio component that is remotely coupled to the electronics device 120. For example, the audio output 123 may include a headset, headphones, or earbuds that may be coupled to communications device with a wire (e.g., coupled to electronics device 120 with a jack) or wirelessly (e.g., Bluetooth® headphones or a Bluetooth® headset).

In one embodiment, the display 121 may include any suitable screen or projection system for providing a display visible to the user. For example, display 121 may include a screen (e.g., an LCD screen) that is incorporated in the electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app), social networking applications (e.g., Facebook®, Twitter®, etc.), an Internet browsing application, etc. In some embodiments, the electronics device 120 may include one or multiple applications operative to perform communications operations. For example, the electronics device 120 may include a messaging application, a mail application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include microphone 122 to allow the user to transmit audio (e.g., voice audio) for speech control and navigation of applications 1-N 127, during a communications operation or as a means of establishing a communications operation or as an alternative to using a physical user interface. The microphone 122 may be incorporated in the electronics device 120, or may be remotely coupled to the electronics device 120. For example, the microphone 122 may be incorporated in wired headphones, the microphone 122 may be incorporated in a wireless headset, the microphone 122 may be incorporated in a remote control device, etc.

In one embodiment, the camera module 128 comprises one or more camera devices that include functionality for capturing still and video images, editing functionality, communication interoperability for sending, sharing, etc., photos/videos, etc.

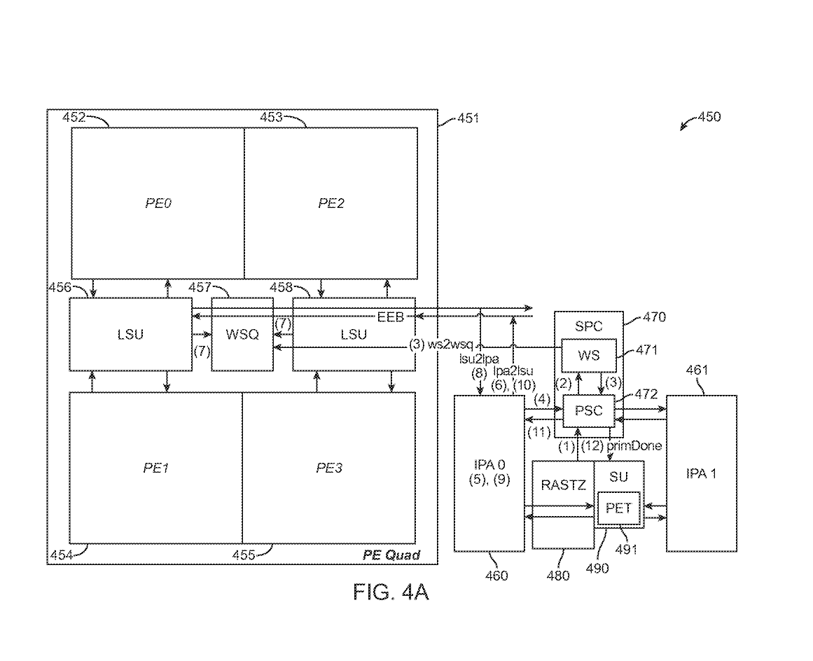

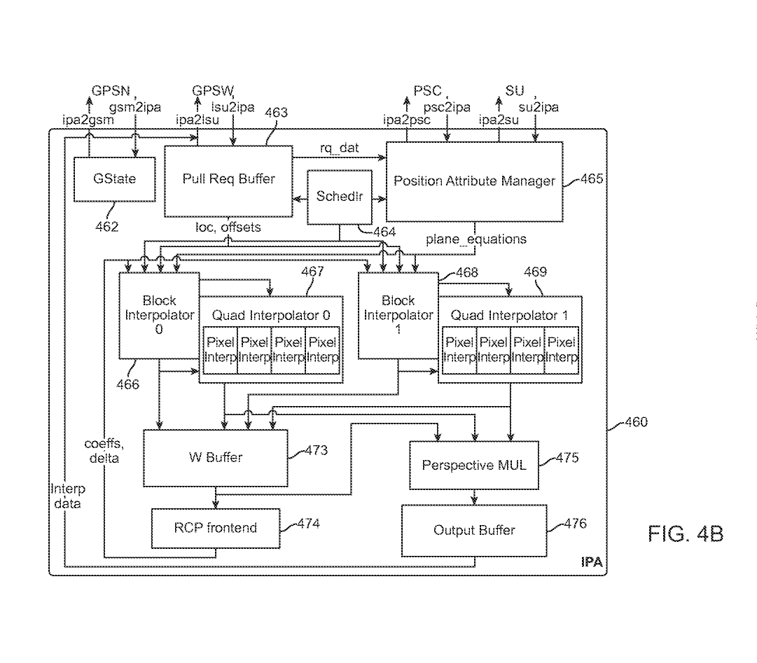

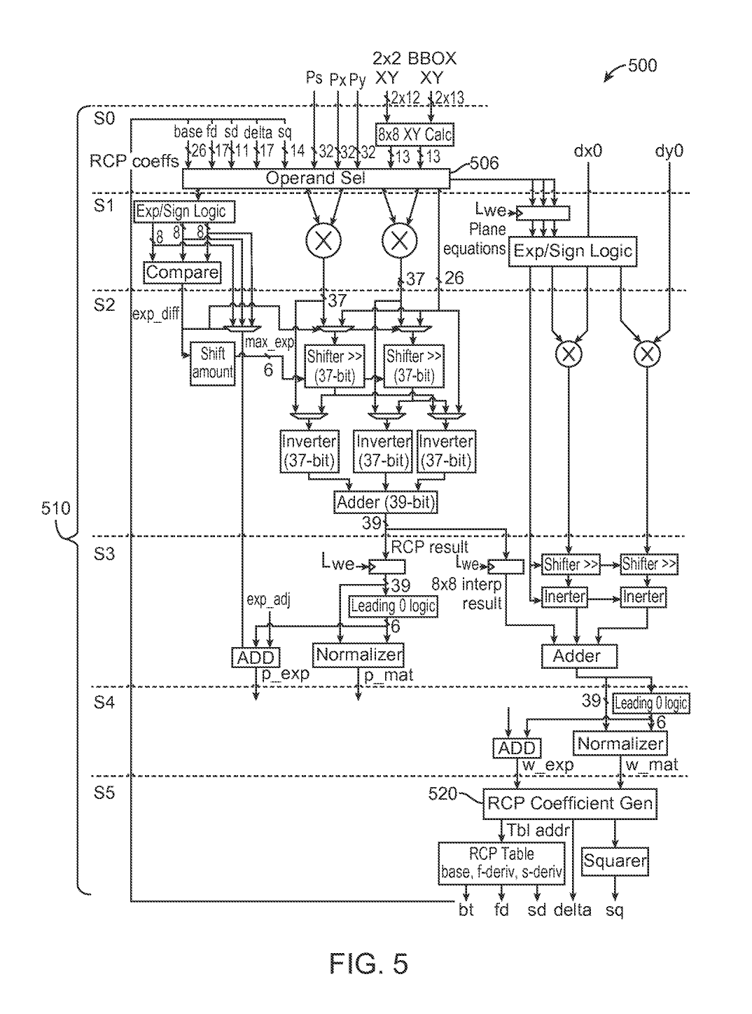

In one embodiment, the GPU module 129 comprises processes and/or programs for processing images and portions of images for rendering on the display 121 (e.g., 2D or 3D images). In one or more embodiments, the GPU module may comprise GPU hardware and memory (e.g., IPA 460, FIGS. 4A-B, ALU 500, FIG. 5, static random access memory (SRAM), dynamic RAM (DRAM), processing elements, cache, etc.).

In one embodiment, the electronics device 120 may include any other component suitable for performing a communications operation. For example, the electronics device 120 may include a power supply, ports, or interfaces for coupling to a host device, a secondary input mechanism (e.g., an ON/OFF switch), or any other suitable component.

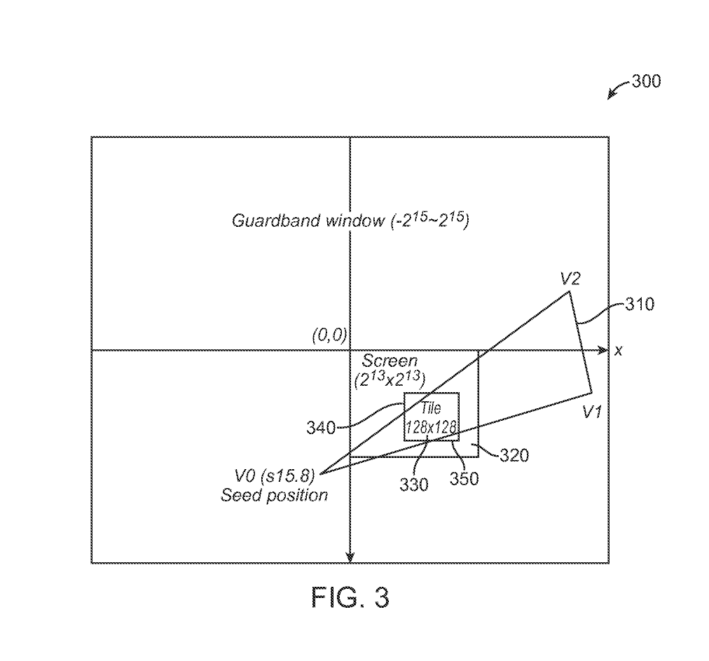

FIG. 3 shows an example triangle scheme 300 used for attribute interpolation, according to an embodiment. The rasterization engine in conventional GPUs calculates the plane equation base parameter Aₛ at a device screen 320 origin (0, 0) for every triangle (e.g., triangle 340, 350, etc.), which requires an extra interpolation to be performed with an IPA from the triangle seed point to (0, 0). The conventional interpolation also introduces potential graphics quality issues due to the arithmetic errors in floating-point interpolation. Alternative solutions use the attribute value of the triangle seed position (vertex 0 in example 300) as the plane equation base parameter. The Aₛ interpolation is saved and the precision is improved. The seed position can be everywhere within the guardband window, however, the cost (e.g., processing cost, memory usage cost, physical hardware area cost) of the pixel interpolator increases due to the guardband being significantly larger than the screen size and the tile size. Therefore, the bit width of the interpolator logic is much larger due to the extra bits in the X and Y coordinates.

One or more embodiments adaptively perform the Aₛ interpolation based on the location of the triangle seed point, when the triangle seed point is inside the tile 330 being rendered. In one embodiment, the attribute of the seed vertex (V₀) is used as the plane equation base parameter in pixel interpolation. In one embodiment, the calculation of Aₛ is then saved. In one embodiment, when the seed point is outside the current tile 330, Aₛ is calculated at 320 in a triangle 310 setup.

FIG. 4A shows an example block diagram 450 for an IPA (e.g., IPA 0 460, IPA 1 461) top-level data flow, according to an embodiment. The top level control flow for the IPA is explained as follows. In one embodiment, the Raster and Z unit (RASTZ) 480 sends quads of pixels to the Pixel Shader Constructor (PSC) 472 of the SPC 470 with information, such as X, Y coordinates, pixel or sample masks, primitive IDs, primitive and draw end information. In one example, the PSC 472 constructs a Pixel Shader (PS) warp that contains 8 quads (or 16 quads when braiding is on) and makes a request to the Warp Scheduler (WS) 471. The WS 471 allocates a Warp ID and passes it back to the PSC 472, notifies the Warp Sequencer (WSQ) 457 to prepare the warp for execution. The PSC 472 passes the warp ID, the pixel quad's X, Y coordinates, masks and primitive info to the IPA 0 460. The IPA 0 460 starts interpolation based on the Push IPA attribute mask and the interpolation modes in the GState.

In one embodiment, the IPA 0 460 sends push mode interpolation results to the vector Register File in a Processing Element (PE) (e.g., 452, 453, 454 or 455) of the PE Quad 451 through a Load Store Unit (LSU) (e.g., 456 or 458). The LSU notifies the WSQ 457 after writing last attribute data for a warp to the vector Register File, so that the WSQ 457 updates the status of the warp and makes it ready for shader execution. In one embodiment, if the Pull IPA mode is enabled, the Pixel Shader will make pull IPA requests by executing the pull IPA instructions. The IPA 0 460 performs pull mode interpolation. The IPA 0 460 sends pull mode interpolation results to the vector Register File in the PE through the LSU.

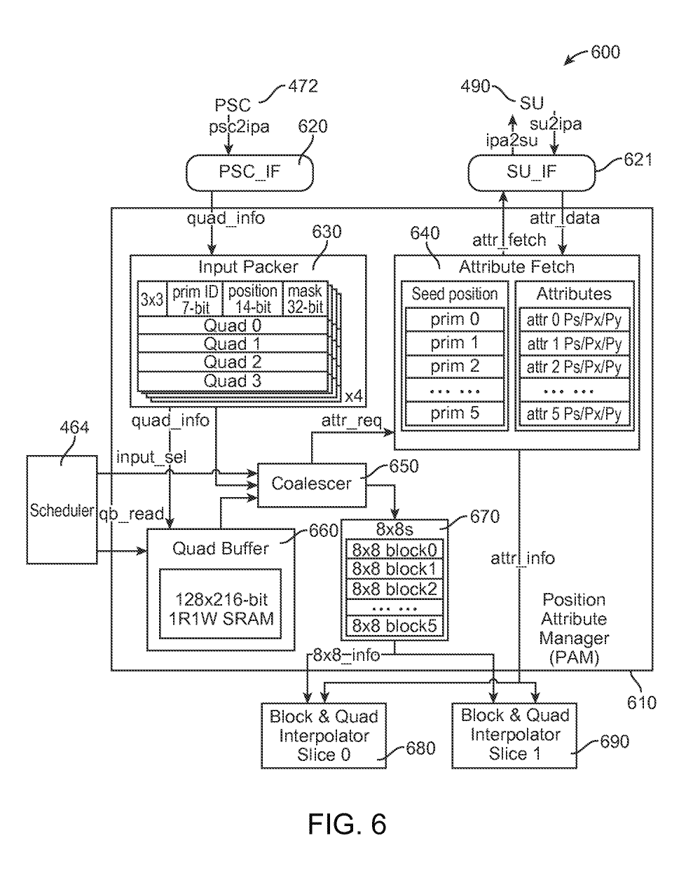

In one embodiment, the IPA 0 460 passes primitive done signal to the PSC 472 when it finishes a primitive. When the PSC 472 receives the primitive done signals for a primitive from both IPA 0 460 and IPA 1 461, it will return the final primitive done signal to the Setup Unit (SU) 490. The SU 490 also includes the plane equation table (PET) 491 that supplies attribute plane equations and triangle seed positions to the shared block interpolator and reciprocal unit (SBR) (e.g., 680, 690, FIG. 6).

In one embodiment, the IPA GState specifies whether the Push mode and Pull mode interpolation are enabled. In one embodiment, when the Pull IPA is off: the IPA 0 460 (or IPA 1 461) interpolates all attributes and pushes the results into the Register File in a PE (e.g., PE 0 452, PE 1 454, PE 2 453 or PE 3 455) based on the Push to Register File attribute mask defined in the GState. In one example, the Push to Register File attribute mask contains 128 bits, and each bit represents a valid flag that specifies whether the associated scalar attribute component needs to be pushed to the Register File. The plane equations are released as soon as all interpolation associated with the primitive is completed. The plane equations are generated by the SU 490 and stored in the PET 491.

In one embodiment, when the Pull IPA is on: the IPA 0 460 (or IPA 1 461) interpolates a portion of attributes and performs a push based on the Push to Register File attribute mask. In one example, the Pixel Shader executes the pull interpolation instruction includes a 16-bit mask to specify which of the 16 consecutive attribute components to interpolate and send to the Register File. The pull IPA instruction supports DX11/OpenGL4.x style programmable pixel offset interpolation. The interpolation mode per PS input element (V#) is defined in the IPA GState based on the shader declaration. The pull IPA instruction may override the interpolation location defined in the IPA GState. In one embodiment, the last request of the pull IPA instruction must specify the “end” flag so that the IPA can manage to release the data structures related to the pixel shader warps and return the primitive done signal to the SU 490 to release the plane equations.

FIG. 4B shows an example block diagram for an IPA 0 460 (or IPA 1 461), according to an embodiment. In one embodiment, the block diagram for the IPA 460 shows the interfaces for the PSC 472, setup 490, GPSN, and GPSW. In one embodiment, the IPA 0 460 includes one or more block interpolators (e.g., block interpolator 0 466, 1 468, etc.), one or more pixel interpolators of quad interpolator 0 467, 1 469, an W buffer 473, shared block and reciprocal unit (RCP frontend) 474, output buffer 476, perspective correction multiplier (PCM) or perspective MUL 475, GState 462, PRB 463, scheduler 464 and Position Attribute Manager (PAM) 465.

In one embodiment, the IPA 0 460 handles the varying attribute interpolation at every pixel or sub-sample as well as a merger of the pixel screen (e.g., screen 320, FIG. 3) coordinates to the Pixel shader inputs. In one embodiment, the varying attribute interpolation is performed at two stages, the first is a block level base interpolation using the block interpolator (e.g., block interpolator 0 466 or block interpolator 1 468) at the center of an 8×8 pixel block, and the second is a pixel level interpolation within the 8×8 pixel block.

In one embodiment, as soon as the IPA 0 460 receives the XY screen coordinates of a 2×2 or 3×3 pixel quad and there is space available in the output buffer 476, the IPA 0 460 will start processing the pixel block.

In one embodiment, when a primitive covers more than one 2×2 or 3×3 quad in the 8×8 pixel block, the IPA Control (IPA CTL) performs optimizations to reuse the existing 8×8 interpolation result without recalculating the result as well as avoiding any unnecessary plane equation reads, which reduces resource consumption (e.g., processing power, physical hardware area, etc.).

In one embodiment, the PAM 465 receives the pixel quad information for the PSC 472 and packs the quad positions, pixel and sample masks, primitive IDs and 3×3 quad flags into warp data structures. The PAM 465 further requests the attribute plane equations and triangle seed positions from the PET 491 in the SU 490 and passes the information to the shared block interpolator/reciprocal unit (SBR) 466 to perform the push mode interpolation.

In one embodiment, the PRB 463 stores the Pull IPA requests from the PE (e.g., PE 0 452, PE 1 454, PE 2 453 or PE 3 455, FIG. 4A) which contains the interpolation precision, perspective division enable flag, interpolation location, start attribute slot number and component mask, the valid lane mask, programmable pixel offset and sample index and request synchronization flags for each Pixel Shader warp.

In one embodiment, the interpolation is split into two steps: 8×8 block interpolation and pixel interpolation. For pixels within the same 8×8 block, the block results can be re-used, allowing the block interpolator (e.g., block interpolator 0 466, block interpolator 1 468, FIG. 4B) to be used for reciprocal calculations. As can be seen from the two equations below, the computation requirements are very similar.

block interpolation: Vb=Ps+(Xb−Xs)*Px+(Yb−Ys)*Py

bits: 42=24+16*24+16*24

reciprocal: f(1/x)=c0−c1*(x−a)+c2*(x−a)̂2

bits: 26−17*17+11*14.

In one embodiment, the SBR 466 receives the attribute plane equations, triangle seed positions and the X, Y coordinates of the 8×8 block that the input pixel quads reside in and performs the block interpolation. The result of the block interpolation is forwarded to the Quad Pixel Interpolator (e.g., quad pixel interpolator 0 467, quad pixel interpolator 1 469) and used as the base for the quad pixel interpolation. The SBR 466 also performs the reciprocal calculation of the W value used in the perspective correction.

In one embodiment, the quad pixel interpolator performs the quad pixel interpolation based on the attribute plane equations, the 8×8 block interpolation results and the X, Y offsets of the pixels within the 8×8 block. In one example, the W buffer (WBF) 473 stores the interpolated W values from quad pixel interpolator as well as the W reciprocals from the SBR 466, and it sends the interpolated W values to the SBR 466 for reciprocal calculation and W reciprocals to the PCM 475 for the final multiplication.

In one embodiment, the Scheduler (SCH) 464 schedules between push mode and pull mode interpolation requests on a per warp basis, and also sequences the requests of the SBR 466 and the quad pixel interpolator for block, pixel interpolation and W reciprocal calculation.

The PCM 475 performs the multiplication of W reciprocals with every interpolated attribute value at the selected interpolation location. The Output Buffer (OBF) 476 collects the final outputs of the interpolation results after perspective correction. The OBF 476 compensates the latency of the interpolation pipeline and helps to smooth out the output traffic to the interconnect buses.

FIG. 5 shows an example block diagram of an arithmetic logic unit (ALU) 500 of the IPA 0 460 (FIG. 4B), according to an embodiment. In one embodiment, the reciprocal coefficient generation unit (RCP) 520 is positioned in the last stage (S5) of the different stages 510 (S0-S5) of the common data path. In one or more embodiments, the common data path is used for interpolation and reciprocal logic flowing from the operand select 506 of the IPA 460 (e.g., of the block interpolator 0 466 or block interpolator 1 468) for the different stages S0-S5 510.

In one embodiment, the block interpolator 0 466 or block interpolator 1 468 is shared with the reciprocal quadratic interpolation logic of S5 that is used for perspective division.

FIG. 6 shows an example PAM 610 block diagram 600, according to an embodiment. The PAM 610 controls the input position and access to attributes. In one example, the PAM 610 includes the PSC interface 620, SU interface 621, and receives outputs to the block and quad interpolator slice 0 680 and the block and quad interpolator slice 1 690. In one embodiment, when the PAM 610 receives the 2×2 or 3×3 quad position and mask from PSC 472, it starts packing the quad information into a warp data structure in the input packer unit 630. The packed quad information is then passed to the coalescer unit 650 for the push IPA processing as well as saved to the quad buffer 660 when the pull IPA is enabled.

In one embodiment, the PSC interface 620 may provide one 2×2 or 3×3 quad per cycle and each quad buffer 660 entry holds four quads of positions, primitive IDs and sample masks, in order to keep the pipeline going; the input packer 630 should keep at least four quads of information.

In one embodiment, the quad buffer 660 can hold 32 warps each including 16 quads. When the pull IPA is enabled, the quad information needs to be kept until the last pull request in the pixel shader PS finishes, which may be close to the entire pixel shader lifetime. In one example, the data in the quad buffer 660 for each quad: 3×3: is 3×3 quad; primID: 7 bits; position X, Y: 7 bits ×2; mask: 32 bits, up to 8×MSAA; 54 bits/quad*16 quads/warp*32 warps=27,648 bits.

The coalescer unit 650 groups the 2×2 or 3×3 quads based on their 8×8 670 locations and primIDs; the quads within the same 8×8 that have the same primID are merged into one single attribute request to the PET 491 (FIG. 4A) in the SU 490. In one embodiment, in order to meet the target rate of two quads per cycle, the coalescer unit 650 and the attribute fetch unit 640 should maintain six 8×8 data structures, six triangle seeds and six attributes to compensate the PET fetch latency.

In one embodiment, the coalescer unit 650 maintains the quad indexes for these 8×8 670 data structures and use these to generate the destination addresses in the output buffer 476 (FIG. 4B). Each entry in the seed buffer contains 14 bits of (X, Y) coordinates, and each primitive has its own seed position. The quad information and seed positions are read repeatedly in a loop for the interpolation of all attributes within a warp. In one embodiment, if the warp has less than six primitives and 8×8 blocks, then the six entries of the current warp seed buffer are sufficient to avoid any re-fetch from the PET 491. If there are more than six primitives and 8×8 blocks, then the data would be re-fetched from the PET 491.

Each entry in the attribute buffer contains 96 bits for the three floating point 32 numbers (Ps, Px, Py). Based on the GState attribute table and the list of primitives, the order of retrieval from the PET 491 is defined. If there is a perspective mode, then the W attributes are read first. Otherwise, the process starts with (attribute 0, component 0).

Since the attributes in the PET 491 are packed by the SU 490, the attribute fetch unit 640 needs to translate the logic Attribute Slot IDs specified in the GState table or the pull IPA requests to the packed attribute offsets in the PET 491. The IPA 0 460 (or IPA 1 461) may generate the correct address mapping table when the GStates are loaded to the local state buffer.

In one embodiment, the second section of this PAM 610 uses the position data from the input buffers to compute the block and pixel offsets. In one example, the seed position is a pair of 15-bit numbers in unsigned 7.8 format. The 7-bit integer supports a tile of 128×128 pixels, and the 8-bit fraction supports 64×64 sub-pixels. If the actual seed position is located in the tile, the position and pixels are presented as-is from the SU 490. Otherwise, pixels are pre-interpolated to the first rasterized pixel or sample within the tile. These two conditions are transparent to the IPA 0 460 (or IPA 1 461). The quad position is a pair of unsigned 7-bit integers within a 128×128 tile.

In one embodiment, the interpolation is performed in two steps, and two sets of position offsets are required. In one example, for the first offset, block offset: attributes are interpolated to the origin of an 8×8 block, so all pixels within the 8×8 block may use that result as the starting point, reducing the number of computations. Block offset from seed is a signed 8.8 number. For the second offset, pixel offset: this offset uses unsigned 4.4 format. The lower 3-bit integer defines a location within the 8×8 block, the MSB provide an extra guard bit to support out of 8×8 range interpolation for a 3×3 quad. The 4-bit fraction supports 16×16 sub-pixels which are used by various interpolation modes. The pixel offsets are computed in stage 1 to minimize data toggling. If the pixel mask is 0 (from stage 0), then that pixel's section is disabled.

In one embodiment, there are three interpolation modes: (1) constant: use pixels from the PET 491 (no position dependency); (2) linear interpolation; (3) linear interpolation with perspective division. There are four interpolation locations:

1. Center: quad position=(Xq, Yq)

P0=(Xq+0.5, Yq+0.5)

P1=(Xq+1.5, Yq+0.5)

P2=(Xq+0.5, Yq+1.5)

P3=(Xq+1.5, Yq+1.5).

2. Centroid: based on the MSAA mode, if all sampling points are covered by the primitive, the pixel position is at the center of the 16×16 sub-pixels (same as the linear mode). Otherwise, the first covered sampling point is the pixel position.
3. Sample: these are the three MSAA modes, shown as 16×16 sub-pixels: the number of quads is multiplied by the sampling frequency. For example, if there are two quads (P3 P2 P1 P0) and (P7 P6 P5 P4) at the input, and two sampling points S0 and S1 in the 2×MSAA mode, then four quads are generated and contribute 16 pixels toward the 128-pixel maximum/warp.
S0 of original quad (P3 P2 P1 P0)->new quad (P03 P02 P01 P00)
S1 of original quad (P3 P2 P1 P0)->new quad (P07 P06 P05 P04)
S0 of original quad (P7 P6 P5 P4)->new quad (P11 P10 P09 P08)
S1 of original quad (P7 P6 P5 P4)->new quad (P15 P14 P13 P12).
4. Snapped, supported in the pull IPA request only: the sub-pixel sample locations are provided by the shader instructions in pull IPA request.

Table 1 shows the summary of the data types used by the PAM 410.

TABLE 1

| Data Type | Description |
|---|---|
| (Ps, Px, Py) | attribute component, 32-bit floating point (even |
| | in HP mode) |
| | Ps: constant parameter at the seed position |
| | Px, Py: position dependent parameters |
| (Xs, Ys) | seed position, 15-bit unsigned 7.8 fixed point |
| (Xq, Yq) | quad position, 7-bit unsigned integer |
| (Xb, Yb) | 8 × 8 block position, 4-bit unsigned integer, |
| | extracted from (Xq, Yq) |
| (Xb-Xs, | 8 × 8 block offset from seed, signed 8.8 fixed |
| Yb-Ys) | point |
| (Xp-Xb, | pixel offset from 8 × 8 block, unsigned 4.4 fixed |
| Yp-Yb) | point |

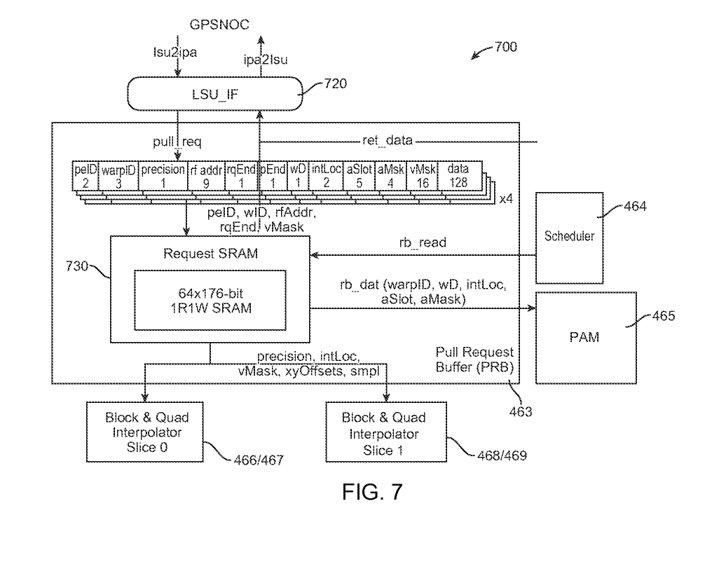

FIG. 7 shows an example PRB 463 block diagram 700, according to an embodiment. In one embodiment, when the Pull IPA mode is enabled, the PE will send Pull IPA requests through the LSU; the request comes with the interpolation result precision (1-bit), the W division enable flag (1-bit), the interpolation location (2-bit), the attribute slot number (5-bit), the attribute component mask (16-bit), the lane valid mask (64-bit), the pixel offset and sample index (8-bit×64=512-bit), the end of current pull request flag and the end of all pull requests flag for each PS warp. In one embodiment, the PRB 463 includes the request SRAM 730, and the LSU interface 720.

In one embodiment, the IPA PRB 463 may hold 16 outstanding IPA requests. The pull requests are processed in the order that they are received. The Warp Sequencer manages the outstanding requests by incrementing the count when a pull IPA request is issued and by decrementing it when a pull request is returned to the PE register file (RF) so that the WSQ 457 (FIG. 4A) ensures the total number will not exceed the size of the PRB 463 in the IPA 0 460 (or IPA 1 461).

In one embodiment, hardware interfaces may comprise various entries for inputs and outputs for: the pixel shader to the IPA 0460 (or IPA 1 461, FIG. 4A) to PSC 472 interface, the IPA 0 460 (or IPA 1 461) to PSC 472 interface, the IPA 0 460 (or IPA 1 461) to SU 490 attribute request interface, the IPA 0 460 (or IPA 1 461) to SU 490 seed request interface, the IPA 0 460 (or IPA 1 461) to SU 490 attribute return interface, the IPA 0 460 (or IPA 1 461) to SU 490 seed return interface, load and store (LSU) to IPA 0 460 (or IPA 1 461) interface, and for the IPA 0 460 (or IPA 1 461) to LSU interface. In one or more embodiments, the interfaces may be amended (e.g., expanded, reduced, adapted, etc.) as required.

In one embodiment, various entries for registers, masks, and modes may include the IPA 0 460 (or IPA 1 461, FIGS. 4A-B) control register entries, the IPA 0 460 (FIGS. 4A-B) control register entries for push to RF address table, the IPA 0 460 (FIGS. 4A-B) control register entries for pull to RF address table, valid mask for component based attributes that are pushed to the Register File in the PE, the number of registers, and bit width.

In one embodiment, a GState table may contain the interpolation mode, the interpolation location and the precision for each varying attribute component. In one embodiment, the attribute components are interpolated in the push IPA phase based on the Push2RFMask mask defined in the GState, the Z and W is placed at the 1^{st} and 2^{nd} attribute component slot. The results of the interpolated attribute components are packed based on the Push2RFMask mask and are sent to the Register File at the starting address specified in StartRFAddr. In one or more embodiments, the entries in the GState table may be amended (e.g., expanded, reduced, adapted, etc.) as required.

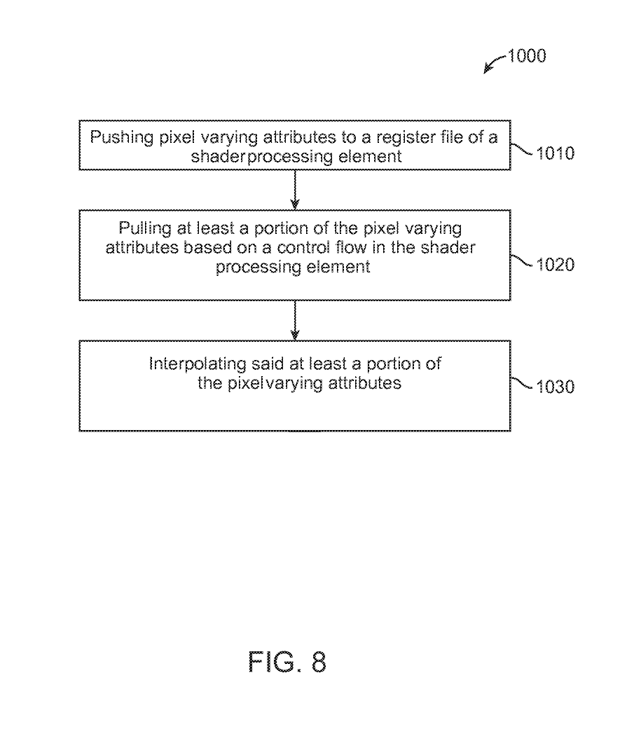

FIG. 8 shows a block diagram for a process 1000 for pixel processing (e.g., using a GPU of GPU module 129, FIG. 2, an IPA 460, FIGS. 4A-B, an ALU 500, FIG. 5, PAM 600, FIG. 6, PRB 700, FIG. 7, etc.), according to one embodiment. In one embodiment, block 1010 provides pushing pixel varying attributes to a register file of a shader processing element. In one embodiment, the pushing of the pixel varying attribute reduces resource consumption (e.g., reduced processing, reduced energy use, reduced physical hardware area required, etc.).

In one embodiment, block 1020 provides pulling at least a portion of the pixel varying attributes based on a control flow in the shader processing element. In one embodiment, block 1030 provides interpolating said at least a portion of the pixel varying attributes (e.g., using the block interpolator 466/468 of the IPA 460).

In one embodiment, process 1000 may include adaptively determining a plane equation base parameter using a vertex of a primitive as an origin, and sharing a large block interpolator (e.g., IPA 0 460, FIGS. 4A-B) with a reciprocal quadratic interpolation logic that is used for perspective division for performing the interpolation.

In one embodiment, the process 1000 may include reusing a result of the interpolation without recalculating and fetching plane equations if a primitive covers a particular area in a tile block. In one embodiment, adaptive determination of the plane equation base parameter is performed upon the primitive determined to reside inside the tile block (e.g., a tile 330, FIG. 3). In one embodiment, in process 1000, the pushed pixel varying attributes includes pushing interpolated pixel varying attributes. In one embodiment, process 1000 may include interpolating at least a portion of the pixel varying attributes by performing hierarchical interpolation for the pixel varying attributes at a center of selected pixel blocks.

In one embodiment, process 1000 may include a texture unit performing preamble texture processing based on a mask, and the mask comprises a push or preload attribute mask. In one embodiment, process 1000 may include pushing the pixel varying attributes and pulling said at least a portion of the pixel varying attributes for reducing processing and resulting in reduced shader PE energy consumption that based on reduced instruction: decode, execution, and latency compensation for interpolation and texture sampling.

In one embodiment, in process 1000 the selected blocks may include an area size larger than a pixel quad. In one embodiment, the particular area in the tile block may comprise more than one pixel quad in the tile block. In one embodiment, in process 1000, a fixed function interpolation unit (e.g., IPA 0 460, FIGS. 4A-B) may be used for interpolating the pixel varying attributes while supporting programmable pixel coordinate offsets. In one embodiment, the fixed function interpolation unit, the shader processing element and the texture unit are part of a GPU of an electronic device (e.g., electronics device 120, FIG. 2).

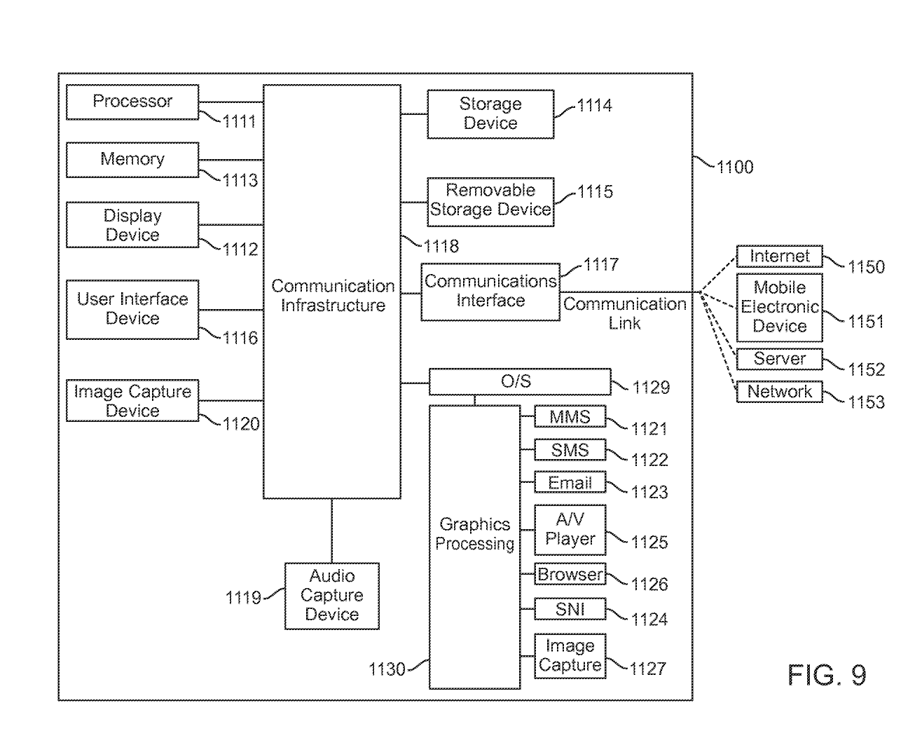

FIG. 9 is a high-level block diagram showing an information processing system comprising a computing system 1100 implementing one or more embodiments. The system 1100 includes one or more processors 1111 (e.g., ASIC, CPU, etc.), and may further include an electronic display device 1112 (for displaying graphics, text, and other data), a main memory 1113 (e.g., random access memory (RAM), cache devices, etc.), storage device 1114 (e.g., hard disk drive), removable storage device 1115 (e.g., removable storage drive, removable memory module, a magnetic tape drive, optical disk drive, computer-readable medium having stored therein computer software and/or data), user interface device 1116 (e.g., keyboard, touch screen, keypad, pointing device), and a communication interface 1117 (e.g., modem, wireless transceiver (such as Wi-Fi, Cellular), a network interface (such as an Ethernet card), a communications port, or a PCMCIA slot and card).

The communication interface 1117 allows software and data to be transferred between the computer system and external devices through the Internet 1150, mobile electronic device 1151, a server 1152, a network 1153, etc. The system 1100 further includes a communications infrastructure 1118 (e.g., a communications bus, cross bar, or network) to which the aforementioned devices/modules 1111 through 1117 are connected.

The information transferred via communications interface 1117 may be in the form of signals such as electronic, electromagnetic, optical, or other signals capable of being received by communications interface 1117, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, tablet, wearable device, etc.), the system 1100 further includes an image capture device 1120, such as a camera 128 (FIG. 2), and an audio capture device 1119, such as a microphone 122 (FIG. 2). The system 1100 may further include application modules as MMS module 1121, SMS module 1122, email module 1123, social network interface (SNI) module 1124, audio/video (AV) player 1125, web browser 1126, image capture module 1127, etc.

In one embodiment, the system 1100 includes graphics processing module 1130 that may implement processing similar as described regarding the triangle scheme 300 (FIG. 3), IPA 0 460, IPA 1 461 (FIG. 4A), and ALU 500 (FIG. 5), etc. In one embodiment, the graphics processing module 1130 may implement the process of flowchart 1000 (FIG. 8). In one embodiment, the graphics processing module 1130 along with an operating system 1129 may be implemented as executable code residing in a memory of the system 1100. In another embodiment, the graphics processing module 1130 may be provided in hardware, firmware, etc.

As is known to those skilled in the art, the aforementioned example architectures described above, according to said architectures, can be implemented in many ways, such as program instructions for execution by a processor, as software modules, micro-code, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for processing pixel information comprising:
pushing pixel varying attributes to a register file of a shader processing element;
pulling at least a portion of the pixel varying attributes based on a control flow in the shader processing element; and
interpolating said at least a portion of the pixel varying attributes.

2. The method of claim 1, further comprising:
adaptively determining a plane equation base parameter using a vertex of a primitive as an origin; and
sharing a large block interpolator with a reciprocal quadratic interpolation logic that is used for perspective division for performing the interpolation.

3. The method of claim 2, further comprising:
reusing a result of the interpolation without recalculating and fetching plane equations if a primitive covers a particular area in a tile block,
wherein adaptively determining the plane equation base parameter is performed upon the primitive determined to reside inside the tile block.

4. The method of claim 3, wherein the pushed pixel varying attributes comprises pushing interpolated pixel varying attributes, wherein interpolating said at least a portion of the pixel varying attributes comprises performing hierarchical interpolation for the pixel varying attributes at a center of selected pixel blocks.

5. The method of claim 4, wherein a texture unit performs preamble texture processing based on a mask, wherein the mask comprises a push or preload attribute mask.

6. The method of claim 5, wherein pushing the pixel varying attributes and pulling said at least a portion of the pixel varying attributes reduces processing and results in reduced shader processing element energy consumption that is based on reduced instruction: decode, execution, and latency compensation for interpolation and texture sampling.

7. The method of claim 6, wherein the selected blocks comprise an area size larger than a pixel quad.

8. The method of claim 7, wherein the particular area in the tile block comprises more than one pixel quad in the tile block.

9. The method of claim 1, wherein a fixed function interpolation unit is used for interpolating the pixel varying attributes while supporting programmable pixel coordinate offsets.

10. The method of claim 9, wherein the fixed function interpolation unit, the shader processing element and the texture unit are part of a graphics processing unit (GPU) of an electronic device.

11. The method of claim 10, wherein the electronic device comprises a mobile electronic device.

12. A method for processing pixel information comprising:
pushing pixel varying attributes to a texture unit;
pulling at least a portion of the pixel varying attributes based on a control flow in the shader processing element; and
interpolating said at least a portion of the pixel varying attributes.

13. The method of claim 12, further comprising:
adaptively determining a plane equation base parameter using a vertex of a primitive as an origin; and
sharing a large block interpolator with a reciprocal quadratic interpolation logic that is used for perspective division for performing the interpolation.

14. The method of claim 13, further comprising:
reusing a result of the interpolation without recalculating and fetching plane equations if a primitive covers a particular area in a tile block,
wherein adaptively determining the plane equation base parameter is performed upon the primitive determined to reside inside the tile block.

15. The method of claim 14, wherein the pushed pixel varying attributes comprises pushing interpolated pixel varying attributes, and wherein interpolating said at least a portion of the pixel varying attributes comprises performing hierarchical interpolation for the pixel varying attributes at a center of selected pixel blocks.

16. The method of claim 15, wherein the texture unit performs preamble texture processing based on a mask, wherein the mask comprises a push or preload attribute mask.

17. The method of claim 16, wherein pushing the pixel varying attributes and pulling said at least a portion of the pixel varying attributes reduces processing that results in reduced shader processing element energy consumption based on reduced instruction: decode, execution, and latency compensation for interpolation and texture sampling.

18. The method of claim 17, wherein the selected blocks comprise an area size larger than a pixel quad.

19. The method of claim 18, wherein the particular area in the tile block comprises more than one pixel quad in the tile block.

20. The method of claim 12, wherein a fixed function interpolation unit is used for interpolating the pixel varying attributes while supporting programmable pixel coordinate offsets.

21. The method of claim 20, wherein the fixed function interpolation unit, the shader processing element and the texture unit are part of a graphics processing unit (GPU) of an electronic device.

22. The method of claim 21, wherein the electronic device comprises a mobile electronic device.

23. A graphics processing unit (GPU) for an electronic device comprising:
one or more processing elements coupled to a memory device, wherein the one or more processing elements:
push pixel varying attributes to a shader processing element register file;
provide functionality to the shader processing element for pulling at least a portion of the pixel varying attributes based on a control flow in the shader processing element; and
perform interpolation using an interpolation unit for said at least a portion of the pixel varying attributes.

24. The GPU of claim 23, wherein the one or more processing elements adaptively determine a plane equation base parameter using a vertex of a primitive as an origin; and
wherein the interpolation unit comprises a large block interpolator that is shared with a reciprocal quadratic interpolation logic that provides perspective division for performing the interpolation.

25. The GPU of claim 24, wherein the interpolation unit performs hierarchical interpolation using the interpolation unit for the pixel varying attributes at a center of selected pixel blocks; and
a result of the interpolation is reused without recalculating and fetching plane equations if a primitive covers a particular area in a tile block.

26. The GPU of claim 25, wherein the plane equation base parameter is adaptively determined upon the primitive determined to reside inside the tile block, and the pushed pixel varying attributes comprise interpolated pixel varying attributes.

27. The GPU of claim 26, wherein a texture unit performs preamble texture processing based on a mask, wherein the mask comprises a push or preload attribute mask, and wherein the push of the pixel varying attributes and pulling said at least a portion of the pixel varying attributes reduces resource consumption by reducing processing and results in reduced shader processing element energy consumption based on reduced instruction: decode, execution, and latency compensation for interpolation and texture sampling.

28. The GPU of claim 26, wherein the selected blocks comprise an area size larger than a pixel quad, and the particular area in the tile block comprises more than one pixel quad in the tile block, wherein the interpolation unit comprises a fixed function interpolation unit that interpolates the pixel varying attributes while supporting programmable pixel coordinate offsets.

29. The GPU of claim 23, wherein the GPU uses a single-instruction multiple-thread (SIMT) processing architecture, and the electronic device comprises a mobile electronic device.

30. A graphics processing unit (GPU) for an electronic device comprising:
one or more processing elements coupled to a memory device, wherein the one or more processing elements:
push pixel varying attributes to a texture unit;
provide functionality to the shader processing element for pulling at least a portion of the pixel varying attributes; and
perform interpolation using an interpolation unit for said at least a portion of the pixel varying attributes.
